(19) United States
(12) Patent Application Publication
(10) Pub. No.: US 2005/0126601 A1
(43) Pub. Date: Jun. 16, 2005

(54) Dishwashing machine and method for controlling the same

(75) Inventors: Tae Young Jung, Hwasung-Si (KR); Jang Woo Lee, Suwon-Si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/923,837

(22) Filed: Aug. 24, 2004

(30) Foreign Application Priority Data
Dec. 15, 2003 (KR) 2003-91388

(51) Int. Cl. B08B 7/04; B08B 3/00

(52) U.S. Cl. 134/25.2; 134/56 D; 134/58 D; 134/198; 134/18

(57) ABSTRACT

A dishwashing machine provided with a controller restricting opening of a door when tableware is washed using heated wash water or dried using hot air. The controller controls a door locking unit to unlock the door when the temperature of the wash water is not greater than a first predetermined temperature. Further, the controller controls the door locking unit to unlock the door when the temperature in a washing compartment is not greater than a second predetermined temperature. The dishwashing machine allows the door to be opened only in a suitable state, providing convenient and safe use by consumers.

### CROSS-REFERENCE TO RELATED APPLICATIONS

This application claims the benefit of Korean Patent Application No. 2003-91388, filed on Dec. 15, 2003 in the Korean Intellectual Property Office, the disclosure of which is incorporated herein by reference.

### BACKGROUND OF THE INVENTION

1. Field of the Invention

The present invention relates to a dishwashing machine using heated wash water and a method for controlling the same, and more particularly to a dishwashing machine in which tableware is washed by heated wash water and is then dried by circulated hot air, and a method for controlling the dishwashing machine

2. Description of the Related Art

A dishwashing machine has a box-shaped structure provided with an opened front surface, and comprises a main body having a washing compartment in which tableware to be washed is contained and a door to open and close the opened front surface.

A tableware basket for stably mounting the tableware thereon and washing the tableware by means of sprayed wash water is installed in the washing compartment, and a collecting reservoir for collecting the wash water therein, a wash water circulating unit for circulating the wash water, and a discharging unit for discharging the wash water are installed under the washing compartment. Further, a plurality of spraying nozzles, connected to the wash water circulating unit, for spraying the wash water to the tableware basket are arranged in the washing compartment. The dishwashing machine further comprises a heating unit for heating the wash water, and a hot air circulating unit for circulating hot air to dry the tableware.

The dishwashing machine is designed such that the door can be opened from the front surface of the main body even while the tableware is being washed or dried. Since the inner surface of the door, arranged adjacent to the heating unit, has a high temperature during the heating of the wash water, if the inner surface of the door comes into contact with a user when the door is opened from the front surface of the main body, the user may suffer burns. Further, in case that the door is opened when the tableware is being washed by the heated wash water, the heated wash water can flow from the main body through the door and contact the user.

Moreover, in case that hot air is being circulated for drying the tableware, if the door is opened from the front surface of the main body when the inner temperature of the washing compartment is very high, the hot air escapes to the outside through the door, thus causing startling and discomfort to the user.

### SUMMARY OF THE INVENTION

Therefore, an aspect of the invention is to provide a dishwashing machine, in which opening of a door is restricted in a washing or drying mode, and a method for controlling the dishwashing machine, to provide safe and convenient use by consumers.

In accordance with one aspect, the present invention provides a dishwashing machine comprising: a washing compartment to wash tableware contained therein; a first heater heating wash water; a water temperature sensor sensing a temperature of the wash water; a door opening and closing the washing compartment; a door locking unit selectively locking the door; and a controller controlling the door locking unit to lock the door when the temperature of the wash water sensed by the water temperature sensor is greater than a first predetermined temperature.

According to one aspect, the controller controls the door locking unit to unlock the door when the temperature of the wash water sensed by the water temperature sensor is not greater than the first predetermined temperature:

According to one aspect, the door locking unit comprises a lever to lock the door, controlled by the controller.

According to one aspect, the dishwashing machine further comprises a water collecting reservoir collecting the wash water therein, wherein the first heater and the water temperature sensor are installed in the water collecting reservoir.

According to one aspect, the dishwashing machine further comprises spraying nozzles spraying the wash water heated by the first heater; and a motor pumping the wash water collected in the water collecting reservoir to the spraying nozzles to circulate the wash water.

According to one aspect, the dishwashing machine further comprises a hot air circulating unit circulating hot air into the washing compartment to dry the tableware; and a compartment temperature sensor sensing a temperature in the washing compartment.

According to one aspect, the hot air circulating unit comprises a second heater and a blowing fan.

According to one aspect, the compartment temperature sensor is installed adjacent to the second heater.

According to one aspect, the controller controls the door locking unit to lock the door when the temperature of the washing compartment sensed by the compartment temperature sensor is greater than a second predetermined temperature.

According to one aspect, the controller controls the door locking unit to unlock the door lock when the temperature of the washing compartment sensed by the compartment temperature sensor is not greater than a second predetermined temperature. [0018] In accordance with another aspect, the present invention provides a dishwashing machine comprising: a washing compartment to wash tableware contained therein; a wash water heater heating wash water; a dry heater heating air in the washing compartment; a water temperature sensor sensing a temperature of the wash water; a compartment temperature sensor sensing a temperature in the washing compartment; a door opening and closing the washing compartment; a door locking unit selectively locking the door; and a controller controlling the door locking unit by comparing at least one of the temperature of the wash water sensed by the water temperature sensor and the temperature of the washing compartment sensed by the compartment temperature sensor to a predetermined temperature.

According to one aspect, the controller controls the door locking unit to lock the door when the temperature of the wash water is greater than a first predetermined temperature or the temperature of the washing compartment is greater than a second predetermined temperature.

According to one aspect, the controller controls the door locking unit to unlock the door when the temperature of the wash water is not greater than the first predetermined temperature or the temperature of the washing compartment is not greater than the second predetermined temperature.

In accordance with yet another aspect, the present invention provides a method for controlling a dishwashing machine, comprising: heating wash water to wash tableware contained in a washing compartment; sensing a temperature of the wash water; comparing the sensed temperature of the wash water to a first predetermined temperature; and controlling a door locking unit to lock a door to the washing compartment when the sensed temperature of the wash water is greater than the first predetermined temperature.

According to one aspect, the controlling the door locking unit to lock the door to the washing compartment when the sensed temperature of the wash water is greater than the first predetermined temperature comprises controlling the door locking unit to unlock the door when the sensed temperature of the wash water in a door locked state is not greater than the first predetermined temperature.

According to one aspect, the method further comprises: circulating hot air into the washing compartment after the washing of the tableware; sensing a temperature in the washing compartment; comparing the sensed temperature in the washing compartment to a second predetermined temperature; and controlling the door locking unit to lock the door to the washing compartment when the sensed temperature in the washing compartment is greater than the second predetermined temperature.

According to one aspect, the controlling the door locking unit to lock the door to the washing compartment when the sensed temperature in the washing compartment is greater than the second predetermined temperature comprises controlling the door locking unit to unlock the door when the sensed temperature in the washing compartment is not greater than the second predetermined temperature.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a perspective view of a dishwashing machine in accordance with an embodiment of the present invention;

FIG. 2 is a cross-sectional view of the dishwashing machine of FIG. 1, taken along the line II-II;

FIG. 3 is a block diagram illustrating a control process applied to the dishwashing machine of FIG. 1; and

FIG. 4 is a flow chart illustrating a method of controlling the dishwashing machine of FIG. 1.

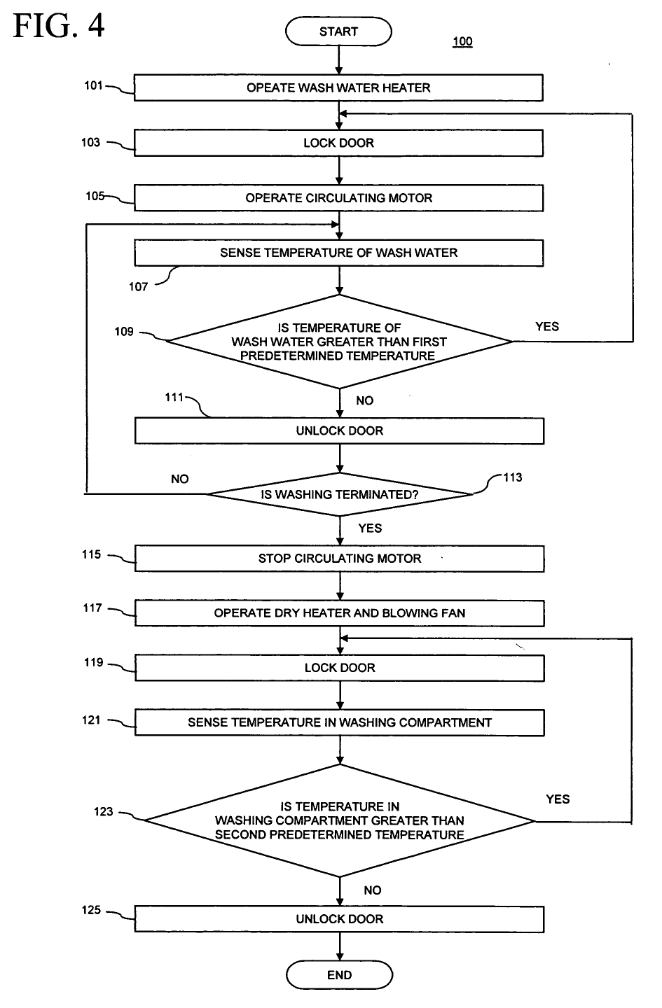

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

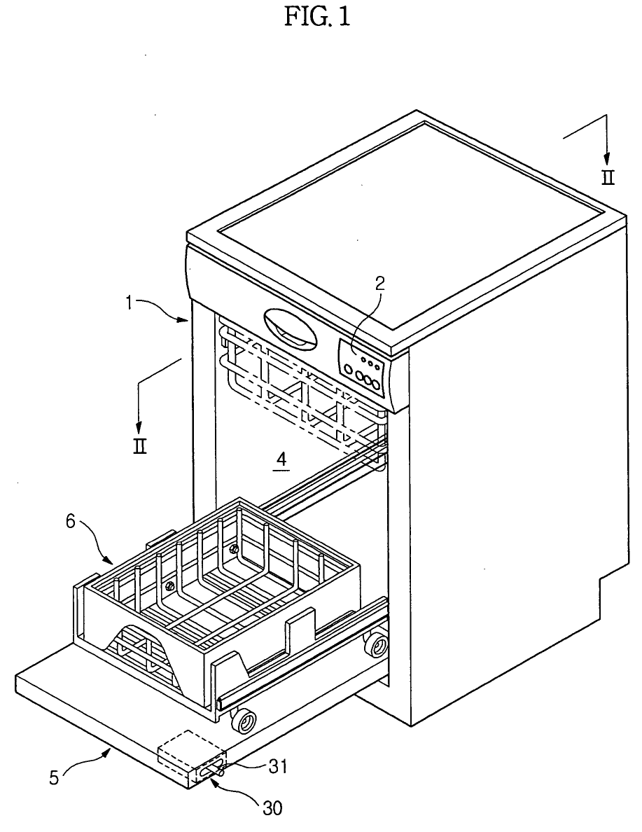

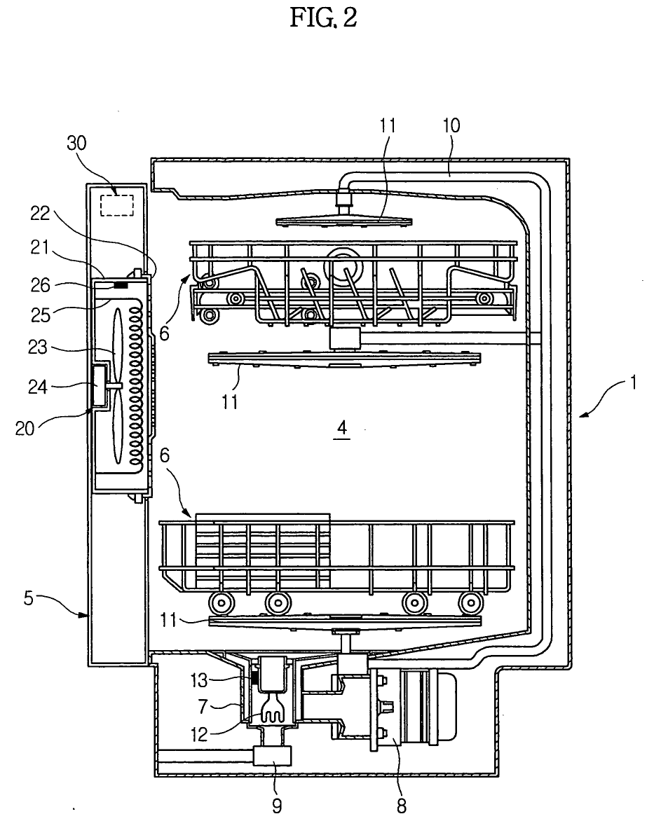

FIGS. 1 and 2 illustrate a structure of a dishwashing machine in accordance with an embodiment of the present invention.

As is shown in FIGS. 1 and 2, the dishwashing machine comprises a box-shaped main body 1 provided with an opened front surface, and a door 5 to open and close the opened front surface of the main body 1.

A door locking unit 30 to lock and unlock the door 5 is installed at the door 5. The door locking unit 30 includes a lever 31 operated under the control of a controller, which will be described later. When the lever 31 is inserted into a groove (not shown) located in a corresponding position of the main body 1, the door 5 is in a locked state. When the lever 31 is removed from the groove, the door 5 is in an unlocked state.

An input unit 2 allowing a user to set input instructions is provided at an outside of the main body 1. A washing compartment 4, in which tableware is washed, is positioned in the main body 1.

A pair of tableware baskets 6 are respectively installed on upper and lower inner surfaces of the washing compartment 4 so that the tableware baskets 6 are movable back and forth. A water collecting reservoir 7, a circulating motor 8 operating a circulating pump to circulate wash water, and a drain motor 9 operating a drain pump to discharge the wash water therethrough are positioned at a lower surface of the washing compartment 4.

A first heater 12 heating the wash water, and a first temperature sensor 13 sensing the temperature of the heated wash water are installed in the water collecting reservoir 7.

The wash water, which is collected in the water collecting reservoir 7, is heated by the first heater 12, pumped through a connection pipe 10 by the operation of the circulating motor 8, and is sprayed by a plurality of spraying nozzles 11, thereby being used to wash the tableware.

The dishwashing machine of the present invention further comprises a hot air circulating unit 20 circulating hot air to remove the remainder of the wash water from the tableware after the washing of the tableware.

The air circulating unit 20 includes a case 21 installed in the door 5. The case 21 includes a second heater 25, a blowing fan 23, and a fan motor 24. A cover unit 22 is connected to an opening of the case 21, and provided with a plurality of air vents, formed therethrough, which serve to transfer the hot air blown by the air blowing fan 23 to the washing compartment 4 and to introduce the air circulated through the washing compartment 4 into the case 21.

The dishwashing machine further comprises a second temperature sensor 26, installed in the case 21, sensing the temperature in the washing compartment 4. Since the second temperature sensor 26 is installed in the case 21, the second temperature sensor 26 recognizes the temperature of the hot air, which is heated by the second heater 25 and blown by the blowing fan 23, as the inner temperature of the washing compartment 4. According to one aspect, as long as the second temperature sensor 26 can sense the inner temperature of the washing compartment 4, the second temperature sensor 26 may be installed in any place other than the case 21.

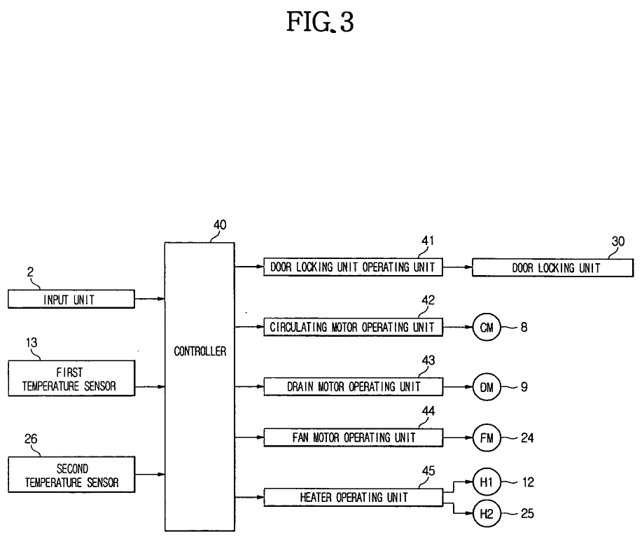

With reference to FIG. 3, the dishwashing machine further comprises a controller 40 controlling an operation of washing the tableware with the heated wash water, an operation of drying the tableware with the hot air, and an operation of controlling the door lock according to the temperatures of the wash water and the washing compartment 4.

The input unit 2 for allowing a user to set input instructions, the first temperature sensor 13 sensing the temperature of the wash water, and the second temperature sensor 26 sensing the temperature of the washing compartment 4 are electrically connected to an input terminal of the controller 40.

A door locking unit operating unit 41 operating the door locking unit 30, a circulating motor operating unit 42 operating the circulating motor 8 circulating the wash water, a drain motor operating unit 43 operating the drain motor 9 discharging the waste wash water after the washing of the tableware, a fan motor operating unit 44 operating the fan motor 24 forcibly blowing the heated air, and a heater operating unit 45 operating the first heater 12 installed in the water collecting reservoir 7 heating the wash water and the second heater 25 installed at the inner side of the door 5 generating hot air by heating are electrically connected to an output terminal of the controller 40.

When the tableware is placed in the washing compartment 4, and washed by the heated wash water or dried by the hot air, the controller 40 selectively restricts the opening of the door 5.

Hereinafter, a method 100 for controlling the dishwashing machine will be described in detail with reference to the drawings.

After the door 5 is opened from the opened front surface of the main body 1 and the baskets 6 are drawn out, tableware to be washed is placed in the baskets 6, the baskets 6 containing the tableware are drawn in, and then the door 5 is closed to the opened front surface of the main body 1.

In operation 101, the controller 40 operates the first heater 12 heating wash water supplied to the water collecting reservoir 7. When the wash water is heated, the controller 40 operates the door locking unit 30 for locking the door 5 in-operation 103. Since the lever 31 is inserted into the groove in a door locked state, the door 5 cannot be opened from the main body 1 even if a user grips and pulls the door 5 from the main body 1. The controller 40 then operates the circulating motor 8 to spray the heated wash water on the tableware in operation 105. The heated wash water is supplied to the spraying nozzles 11 through the connection pipe 10, and is then sprayed onto the tableware, thus removing dried food residue from the tableware.

Next, in operation 107, the first temperature sensor 13 senses the temperature of the wash water, and supplies a signal communicating the sensed temperature of the wash water to the controller 40. The controller 40 receives the signal, and recognizes the signal as the temperature of the wash water. In operation 109, the controller 40 compares the temperature of the wash water to a first predetermined temperature. That is, the controller 40 determines whether or not the temperature of the wash water is greater than the first predetermined temperature. If the temperature of the wash water is greater than the first predetermined temperature, since the opening of the door 5 is unsuitable, the controller 40 returns to operation 103 and maintains the locked state of the door 5, while continuing to monitor the temperature of the wash water. On the other hand, once the temperature of the wash water is not greater than the first predetermined temperature, since the wash water does not pose any danger to the user, the controller 40 unlocks the door in operation 111.

Thereafter, in operation 113, the controller 40 determines whether or not the washing of the tableware using the heated wash water is terminated. If the washing of the tableware is not terminated, the controller 40 returns to operation 107 to complete the washing of the tableware using the heated wash water. On the other hand, once the washing of the tableware is terminated, the controller 40 stops the operation of the circulating motor 8 in operation 115.

After the washing of the tableware is terminated in operation 117, the controller 40 operates the second heater 25 and the blowing fan 23 to circulate hot air in the washing compartment 4. The hot air heated by the second heater 25 is forcibly blown to the air-blowing fan 23, and the circulation of the hot air rapidly dries water on the tableware. After beginning operation of the second heater 25 and the blowing fan 23, the controller 40 operates the door locking unit 30 to lock the door 5 in operation 119.

In operation 121, the second temperature sensor 26 senses the temperature of the hot air, and supplies a signal communicating the sensed temperature to the controller 40. The controller 40 receives the signal, and recognizes the signal, denoting the temperature of the hot air, as the temperature in the washing compartment 4. In operation 123, the controller 40 compares the temperature of the washing compartment 4 to a second predetermined temperature. That is, the controller 40 determines whether or not the temperature of the washing compartment 4 is greater than the second predetermined temperature. If the temperature of the washing compartment 4 is greater than the second predetermined temperature, since the opening of the door 5 is unsuitable, the controller 40 returns to operation 119 and maintains the locked state of the door 5 while continuing to monitor the temperature of the washing compartment 4. Once the temperature of the washing compartment 4 is not greater than the second designated temperature, since the hot air in the washing compartment 4 does not pose any danger to the user, the controller 40 unlocks the door in operation 125.

As is apparent from the above description, in accordance with embodiments of the present invention, the locking of a door is controlled according to the temperature of wash water in a washing mode of a dishwashing machine, and is controlled according to the temperature in a washing compartment in a drying mode of the dishwashing machine. Accordingly, the dishwashing machine of the present invention allows the door to be opened only in a proper state, thereby being conveniently and safely used by consumers and improving reliability of dishwashing machine products.

Although a few embodiments of the present invention have been shown and described, it would be appreciated by those skilled in the art that changes may be made in this embodiment without departing from the principles and spirit of the invention, the scope of which is defined in the claims and their equivalents.

1. A dishwashing machine comprising:
a washing compartment to wash tableware contained therein;
a first heater heating wash water;
a water temperature sensor sensing a temperature of the wash water;
a door opening and closing the washing compartment;
a door locking unit selectively locking the door; and
a controller controlling the door locking unit to lock the door when the temperature of the wash water sensed by the water temperature sensor is greater than a first predetermined temperature.

2. The dishwashing machine according to claim 1, wherein the controller controls the door locking unit to unlock the door when the temperature of the wash water sensed by the water temperature sensor is not greater than the first predetermined temperature.

3. The dishwashing machine according to claim 1, wherein the door locking unit comprises a lever to lock the door, controlled by the controller.

4. The dishwashing machine according to claim 1, further comprising a water collecting reservoir collecting the wash water therein,
wherein the first heater and the water temperature sensor are installed in the water collecting reservoir.

5. The dishwashing machine according to claim 4, further comprising:
spraying nozzles spraying the wash water heated by the first heater; and
a motor pumping the wash water collected in the water collecting reservoir to the spraying nozzles to circulate the wash water.

6. The dishwashing machine according to claim 1, further comprising:
a hot air circulating unit circulating hot air into the washing compartment to dry the tableware; and
a compartment temperature sensor sensing a temperature in the washing compartment.

7. The dishwashing machine according to claim 6, wherein the hot air circulating unit comprises:
a second heater to heat air to dry the tableware; and
a blowing fan to circulate the air hot air into the washing compartment.

8. The dishwashing machine according to claim 7, wherein the compartment temperature sensor is installed adjacent to the second heater.

9. The dishwashing machine according to claim 6, wherein the controller controls the door locking unit to lock the door when the temperature of the washing compartment sensed by the compartment temperature sensor is greater than a second predetermined temperature.

10. The dishwashing machine according to claim 6, wherein the controller controls the door locking unit to unlock the door lock when the temperature of the washing compartment sensed by the compartment temperature sensor is not greater than a second predetermined temperature.

11. A dishwashing machine comprising:
a washing compartment to wash tableware contained therein;
a wash water heater heating wash water;
a dry heater heating air in the washing compartment;
a water temperature sensor sensing a temperature of the wash water;
a compartment temperature sensor sensing a temperature in the washing compartment;
a door opening and closing the washing compartment;
a door locking unit selectively locking the door; and
a controller controlling the door locking unit by comparing at least one of the temperature of the wash water sensed by the water temperature sensor and the temperature of the washing compartment sensed by the compartment temperature sensor to a predetermined temperature.

12. The dishwashing machine according to claim 11, wherein the controller controls the door locking unit to lock the door when the temperature of the wash water is greater than a first predetermined temperature or the temperature of the washing compartment is greater than a second predetermined temperature.

13. The dishwashing machine according to claim 12, wherein the controller controls the door locking unit to unlock the door when the temperature of the wash water is not greater than the first predetermined temperature and the temperature of the washing compartment is not greater than the second predetermined temperature.

14. The dishwashing machine according to claim 11, wherein:
the controller controls the door locking unit by comparing the temperature of the wash water sensed by the water temperature sensor to a first predetermined temperature and comparing the temperature of the washing compartment sensed by the compartment temperature sensor to a second predetermined temperature; and
the controller controls the door locking unit to
lock the door when the temperature of the wash water is greater than the first predetermined temperature,
lock the door when the temperature of the washing compartment is greater than the second predetermined temperature, and
unlock the door when the temperature of the wash water is not greater than the first predetermined temperature and the temperature of the washing compartment is not greater than the second predetermined temperature.

15. A method for controlling a dishwashing machine, comprising:
heating wash water to wash tableware contained in a washing compartment;
sensing a temperature of the wash water;
comparing the sensed temperature of the wash water to a first predetermined temperature; and
controlling a door locking unit to lock a door to the washing compartment when the sensed temperature of the wash water is greater than the first predetermined temperature.

16. The method according to claim 15, wherein the controlling the door locking unit to lock the door to the washing compartment when the sensed temperature of the wash water is greater than the first predetermined temperature comprises controlling the door locking unit to unlocks the door when the sensed temperature of the wash water in a door locked state is not greater than the first predetermined temperature.

17. The method according to claim 15, further comprising:
circulating hot air into the washing compartment after the washing of the tableware;
sensing a temperature in the washing compartment;
comparing the sensed temperature in the washing compartment to a second predetermined temperature; and
controlling the door locking unit to lock the door to the washing compartment when the sensed temperature in the washing compartment is greater than the second predetermined temperature.

18. The method according to claim 17, wherein the controlling the door locking unit to lock the door to the washing compartment when the sensed temperature in the washing compartment is greater than the second predetermined temperature comprises controlling the door locking unit to unlock the door when the sensed temperature in the washing compartment is not greater than the second predetermined temperature.

19. An apparatus, comprising:
a main body having a washing compartment to wash a dish;
a door selectively opening and closing the washing compartment;
at least one heater heating at least one of wash water to wash the dish and air to dry the dish;
at least one sensor sensing at least one of a temperature of the wash water and a temperature of the washing compartment;
a door locking unit selectively locking the door; and
a controller controlling the door locking unit to lock the door when at least one of the temperature of the wash water and the temperature of the washing compartment is greater than respective predetermined limits.

20. An apparatus, comprising:
a main body having a washing compartment to wash a dish;
a door selectively opening and closing the washing compartment;
a first heater heating wash water to wash the dish;
a first sensor sensing a temperature of the wash water;
a hot air circulating unit circulating air in the washing compartment;
a second sensor sensing a temperature in the washing compartment;
a door locking unit selectively locking the door; and
a controller controlling the door locking unit to
lock the door when the temperature of the wash water is greater than a first predetermined temperatures
lock the door when the temperature of the washing compartment is greater than a second predetermined temperature, and
unlock the door when both the temperature of the wash water and the temperature of the washing compartment are not greater than the respective first and second predetermined temperatures.

21. The apparatus according to claim 20, wherein the hot air circulating unit comprises:
a second heater heating the air in the washing compartment; and
a blowing fan circulating the air in the washing compartment,
wherein the second sensor senses a temperature of the air in the washing compartment.

22. The apparatus according to claim 21, wherein the second sensor is positioned adjacent the second heater.

23. The apparatus according to claim 21, wherein the hot air circulating unit further comprises:
a case installed in the door and housing the second heater and the blowing fan; and
a cover unit connected to an opening in the case and having an air vent for air to communicate between the case and the washing compartment.

24. The apparatus according to claim 20, further comprising a water collecting reservoir to collect water from the washing compartment,
wherein the first heater and the first sensor are positioned in the water collecting reservoir.

25. The apparatus according to claim 24, further comprising:
a drain pump;
a drain motor selectively operating the drain pump to discharge the wash water from the water collecting reservoir;
a circulating pump;
a circulating motor selectively operating the circulating pump to pump the wash water from the water collecting reservoir;
a connection pipe guiding the pumped wash water from the water collecting reservoir; and
a spraying nozzle, spraying the pumped wash water on the dish.

26. The apparatus according to claim 25, further comprising an input unit allowing a user to input instructions for the apparatus, wherein the input unit, the first and second sensors, the hot air circulating unit, the door locking unit, the first heater, the circulating motor, and the drain motor are electrically connected to the controller.

27. A method of controlling a dishwashing machine, comprising:
heating wash water;
locking a door to a washing compartment;
operating a circulating motor to circulate the wash water in the washing compartment;
determining a temperature of the wash water;
determining whether a temperature of the wash water is greater than a first predetermined temperature;
if the temperature of the wash water is greater than the first predetermined temperature, maintaining the door in a locked state and operating the circulating motor until the temperature of the wash water is not greater than the first predetermined temperature;
if the temperature of the wash water is not greater than the first predetermined temperature, unlocking the door;
determining whether a washing operation is terminated;
if the washing operation is not terminated, sensing the temperature of the wash water, operating the circulating motor, and controlling whether the door is locked based on a comparison of the temperature of the wash water to the first predetermined temperature until the washing operation is terminated;
if the washing operation is terminated, stopping the circulating motor;
heating air in the washing compartment and operating a blowing fan to circulate the air in the washing compartment;
locking the door;
sensing a temperature of the washing compartment;
determining if the temperature in the washing compartment is greater than a second predetermined temperature;
if the temperature in the washing compartment is greater than the second predetermined temperature, maintaining the door in a locked state until the temperature in the washing compartment is not greater than the second predetermined temperature;
if the temperature in the washing compartment is not greater than the second predetermined temperature, unlocking the door.

28. A method of controlling a dishwashing machine, comprising:
determining a temperature of wash water;
determining a temperature in a washing compartment;
automatically locking a door to the washing compartment if the temperature of the wash water is greater than a first predetermined temperature;
automatically locking the door to the washing compartment if the temperature of the washing compartment is greater than a second predetermined temperature; and
automatically unlocking the door when the temperature of the wash water and the temperature in the washing compartment are not greater than the first and second predetermined temperatures, respectively.
